(19) United States
(12) Patent Application Publication
(10) Pub. No.: US 2026/0221877 A1
(43) Pub. Date: Jul. 30, 2026

(54) DC-DC CONVERTERS WITH N-CHANNEL HIGH-SIDE SWITCHES USING HIGH-SIDE DRIVERS HAVING LOW VOLTAGE CONTROLS AND FLOATING LEVEL SHIFTERS

(71) Applicant: Empower Semiconductor, Inc., San Jose, CA (US)

(72) Inventor: Bai NGUYEN, Dublin, CA (US)

(73) Assignee: Empower Semiconductor, Inc., San Jose, CA (US)

(21) Appl. No.: 19/041,472

(22) Filed: Jan. 30, 2025

(51) Int. Cl. H02M 3/158

(52) U.S. Cl. CPC H02M 3/158

(57) ABSTRACT

A circuit is disclosed. The circuit includes an input circuit comprising a first and second input terminals, an output circuit comprising a first and second output terminals, a first switch coupled to a second switch, the first and second switches being of a first type of switch, and a third switch coupled to the second switch, the third switch being of a second type of switch. IN one aspect, the first and the second input terminals are referenced to a first voltage that is a ground, and the first and the second output terminals are referenced to a second voltage at a different potential than ground. In another aspect, the first type of switch is characterized as having a first breakdown voltage, where the second type of switch is characterized as having a second breakdown voltage and the first breakdown voltage is less than the second breakdown voltage.

### FIELD

The described embodiments relate generally to power converters, and more particularly, the present embodiments relate to DC-DC converters with N-channel high-side switches using high-side drivers having low voltage controls and floating level shifters.

### BACKGROUND

A wide variety of electronic devices are available for consumers today. Many of these devices have integrated circuits that are powered by regulated low voltage DC power sources. These low voltage power sources are often generated by dedicated power converter circuits that use a higher voltage input from a battery or another power source. In some applications, the dedicated power converter circuit can be one of the largest power dissipating components of the electronic device and can sometimes consume more space than the integrated circuit that it powers. As electronic devices become more sophisticated and more compact, more efficient power converter circuits are called for.

### SUMMARY

In some embodiments, a level shift circuit is disclosed. The level shift circuit includes an input circuit having a first and second input terminals; an output circuit having a first and second output terminals; a first switch coupled to a second switch, the first and second switches being of a first type of switch; a third switch coupled to the second switch, the third switch being of a second type of switch; where the first and the second input terminals are referenced to a first voltage that is a ground, and the first and the second output terminals are referenced to a second voltage at a different potential than ground.

In some embodiments, the first type of switch is characterized as having a first breakdown voltage, where the second type of switch is characterized as having a second breakdown voltage, and where the first breakdown voltage is less than the second breakdown voltage.

In some embodiments, the first type of switch is characterized as having a first gate oxide thickness, and where the second type of switch is characterized as having a second gate oxide thickness.

In some embodiments, the first gate oxide thickness is less than the second gate oxide thickness.

In some embodiments, the first switch is arranged to receive a first of a plurality of control signals and to selectively conduct current according to the first control signal.

In some embodiments, the third switch is arranged to enable the output circuit upon receiving of an enable signal being high.

In some embodiments, the second input terminal is coupled to a gate terminal of the third switch.

In some embodiments, a circuit is disclosed. The circuit includes a first switch coupled to a second switch at a switch node; a driver circuit coupled to the first switch; a first bootstrap switch; a first bootstrap capacitor coupled to the switch node and to the first bootstrap switch, the first bootstrap capacitor arranged to supply a first power voltage to the driver circuit; a pre-driver circuit coupled to the driver circuit; a second bootstrap switch; and a second bootstrap capacitor coupled to the switch node and to the second bootstrap switch, the second bootstrap capacitor arranged to supply a second power voltage to the pre-driver circuit.

In some embodiments, a voltage at the switch node changes between first and second switch node voltages, where the first bootstrap capacitor is arranged to supply the first power voltage while the voltage at the switch node is equal to the second switch node voltage.

In some embodiments, the first bootstrap switch is arranged to couple the first bootstrap capacitor to a power node having the second power voltage while the voltage at the switch node is equal to the first switch node voltage.

In some embodiments, the second bootstrap capacitor is arranged to supply the second power voltage while the voltage at the switch node is equal to the second switch node voltage.

In some embodiments, the second bootstrap switch is arranged to couple the second bootstrap capacitor to a power node having the second power voltage while the voltage at the switch node is equal to the first switch node voltage.

In some embodiments, the pre-driver circuit includes an output of a level shift circuit, a buffer circuit and a deglitching circuit.

In some embodiments, a voltage drop at the second bootstrap capacitor is less than that of the first bootstrap capacitor.

In some embodiments, a method of operating a circuit is disclosed. The method includes providing a first switch coupled to a second switch at a switch node, where the switch node changes between first and second switch node voltages; providing a driver circuit coupled to the first switch; providing a pre-driver circuit coupled to the driver circuit; providing a first bootstrap capacitor coupled to the switch node; supplying, by the first bootstrap capacitor, a first power voltage to the driver circuit; providing a second bootstrap capacitor coupled to the switch node; and supplying, by the second bootstrap capacitor, a second power voltage to the pre-driver circuit.

In some embodiments, the method further includes providing a first bootstrap switch coupled to the first bootstrap capacitor.

In some embodiments, the method further includes providing a second bootstrap switch coupled to the second bootstrap capacitor.

In some embodiments, the first bootstrap capacitor is arranged to supply the first power voltage while the voltage at the switch node is equal to the second switch node voltage.

In some embodiments, the first bootstrap switch is arranged to couple the first bootstrap capacitor to a power node having the second power voltage while the voltage at the switch node is equal to the first switch node voltage.

In some embodiments, the second bootstrap capacitor is arranged to supply the second power voltage while the voltage at the switch node is equal to the second switch node voltage.

### BRIEF DESCRIPTION OF THE DRAWINGS

FIG. 1 illustrates a simplified schematic of a DC-DC power converter circuit with N-channel MOSFET high-side and low-side switches using high-side drivers having floating level shifters and relatively low voltage controls, according to some embodiments;

FIG. 2 illustrates a schematic of the DC-DC power converter circuit with N-channel MOSFET high-side and low-side switches with main and auxiliary bootstrap capacitors, using high-side drivers having floating level shifters and relatively low voltage controls, according to some embodiments;

FIG. 3 illustrates operational waveforms for the circuit of FIG. 2; and

FIG. 4 illustrates a schematic of the secondary level shifter circuit of FIG. 2, according to some embodiments.

### DETAILED DESCRIPTION

Circuits, devices and related techniques disclosed herein relate generally to power converters. More specifically, circuits, devices and related techniques disclosed herein relate to DC-DC power converters with N-channel MOSFET high-side switches using high-side drivers having floating level shifters and relatively low voltage controls. In some embodiments, a high-side driver circuit can include a floating level shifter that can operate at a relatively low supply voltage while withstanding relatively high floating voltages. In various embodiments, an auxiliary bootstrap capacitor can be used in addition to a main bootstrap capacitor to reduce effects of a bootstrap voltage drop on a delay of the high-side driver. In some embodiments, a level-shifter may employ a stack of one thick-oxide N-channel MOSFET and two thin-oxide N-channel MOSFETs in order to increase voltage headroom for the thick-oxide N-channel MOSFET and reduce voltage stresses on the thin-oxide N-channel MOSFETs.

In various embodiments, a DC-DC power converter may have an auxiliary bootstrap capacitor for powering pre-drive circuits of the high-side driver in addition to a main bootstrap capacitor for powering drivers for the high-side FET. In some embodiments, a capacitance value of the main bootstrap capacitor can be greater than a capacitance value of the auxiliary capacitor. By using an auxiliary bootstrap capacitor, a voltage drop for the pre-drive circuits can be minimized thereby reducing delay times in the pre-drive circuits. Further, delay times for the high-side and low-side circuits can be matched with relatively high accuracy thereby preventing shoot-through in the half-bridge. In various embodiments, a high-side driver may have first and second bootstrap capacitors, first and second switches to control the on/off state of the first and second bootstrap capacitors, and two buses. By employing an auxiliary capacitor and a main capacitor, noise can be reduced on the pre-drive circuits while auxiliary capacitor can operate with relatively low noise while the main capacitor may operate with relatively high noise.

In some embodiments, the auxiliary bootstrap capacitor can be separated from the main bootstrap capacitor in order to reduce a voltage mismatch that may exist between the high-side and low-side drivers. In various embodiments, a low power circuit may be used to reliably turn off a high-side power switch when internal supply voltages are relatively low. Embodiments of the disclosure enable relatively high operating speed of the DC-DC converter and enable operation with relatively low voltage when using thick-oxide N-channel MOSFET. Moreover, delay mismatches between the high-side and low-side drivers can be reduced, particularly at low power supply voltages. Embodiments of the disclosure further enable increased range of operation of the flying high-side gate voltage by an additional thin-oxide voltage. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

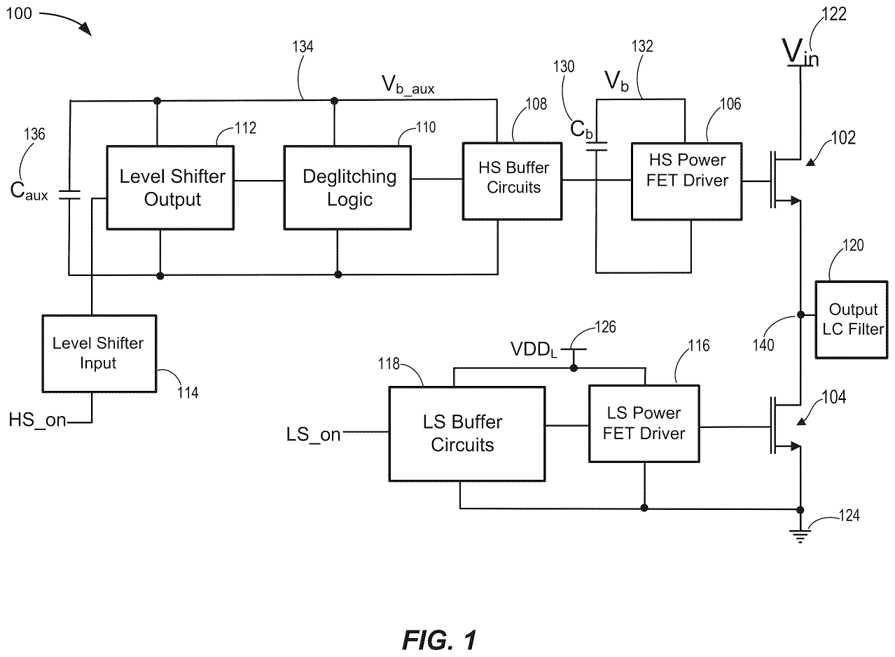

FIG. 1 illustrates a simplified schematic of a DC-DC power converter circuit with N-channel MOSFET high-side and low-side switches using high-side drivers having floating level shifters and relatively low voltage controls, according to some embodiments. In the illustrated embodiment, a circuit 100 may include a high-side N-Channel switch 102 coupled to a low-side N-Channel switch 104 at a switch node 140. The high-side N-Channel switch 102 can be coupled to an input terminal 122 having a voltage Vin. The low-side N-Channel switch 104 can be coupled to a ground 124. An output inductor/capacitor (LC) filter 120 may be couped to the switch node 140. A high-side power FET driver 106 may be coupled to the high-side N-Channel switch 102 and low-side power FET driver 116 may be coupled to the low-side N-Channel switch 104. The low-side power FET driver 116 may be coupled to a power supply terminal 126 having a voltage VDD_{L}. High-side buffer circuits 108 may be coupled to the high-side power FET driver 106. A deglitching logic circuit 110 may be coupled to the high-side buffer circuits 108. Level shifter output circuits 112 can be coupled to the deglitching logic circuit 110. The Level shifter output circuits 112, the deglitching logic circuit 110 and the high-side buffer circuits 108 may be coupled to an auxiliary bootstrap power supply terminal 134 having a voltage Vb_aux.

The circuit 100 can include a bootstrap capacitor (Cb) 130 and an auxiliary bootstrap capacitor (Caux) 136. The bootstrap capacitor 130 can be coupled to the high-side power FET driver 106 and arranged to generate a bootstrap power supply Vb 132. The auxiliary bootstrap capacitor 136 can be coupled to the high-side buffer circuits 108, deglitching logic circuit 110 and level shifter output circuits 112, and arranged to generate an auxiliary bootstrap power supply Vb_aux 134. Circuit 100 can further include level shift input circuits 114 that is coupled to the level shifter output circuits 112. The level shift input circuits 114 can be arranged to receive high-side input signals (HS_on). The low-side power FET driver 116 may be coupled to low-side buffer circuits 118. A low-side power suppl (Vdd_{L}) may be coupled to the low-side power FET driver 116 and low-side buffer circuits 118.

The high-side and low-side sections of the circuit may include numerous circuits used for the control and operation of the high-side N-Channel switch 102 and the low-side N-Channel switch 104, including logic, control, bootstrap charging circuits and level shift circuits that can control the switching of high-side N-Channel switch 102 and the low-side N-Channel switch 104. In circuit 100, the auxiliary bootstrap capacitor 136 can be used for powering pre-drive circuits of the high-side driver while the main bootstrap capacitor 130 can be used for powering drivers for the high-side FET 102. By using the auxiliary bootstrap capacitor 136, a voltage drop for the pre-drive circuits can be minimized thereby reducing delay times in the pre-drive circuits. Further, by using the auxiliary capacitor in addition to the main bootstrap capacitor, delay times for the high-side pre-drive circuits and low-side pre-drive circuits can be matched with relatively high accuracy thereby preventing shoot-through in the half-bridge formed by the high-side N-channel switch 102 and the low-side N-channel switch 104. Further, noise can be reduced on the pre-drive high-side circuits since the auxiliary bootstrap capacitor 136 can operate with relatively low noise as compared to the relatively noisy main bootstrap capacitor 130. Moreover, voltage mismatch between high-side and low-side drivers can be reduced. Furthermore, at low power supply voltages delay mismatches between the high-side and low-side drivers can be reduced.

In some embodiments, the level shift input circuit 114 can use multiple thin-oxide and a thick-oxide MOSFET, enabling relatively high operating speed of the power converter while allowing operation with relatively low voltage when using a thick-oxide N-channel MOSFET that may use relatively high voltage its operation. High operating speed is enabled by thin-oxide MOSFETs using reduced drain-source and threshold voltages. Embodiments of the disclosure also enable increased range of operation of the flying high-side gate voltage by an additional thin-oxide voltage. In various embodiments, the floating level shifter is arranged to operate at a relatively low supply voltage while withstanding relatively high floating voltages.

In current complementary MOS (CMOS) processes, thick-gate-oxide metal-oxide-semiconductor (MOS) transistors (thick-oxide) in addition to thin-gate-oxide high performance MOS transistors (thin-oxide) are used. For example, in a 55 nm CMOS process, a thick-oxide transistor may have a gate oxide thickness of, for example, 2 nm, whereas a thin-oxide transistor may have a gate oxide thickness of, for example, 1 nm. The thin-oxide transistors may be relatively fast and power efficient switches having a first breakdown voltage while the thick-oxide transistors may have second breakdown voltages and may be able to withstand relatively higher operating voltages. The first breakdown voltage may be less than the second breakdown voltage. In some embodiments, the thin-oxide switches may be referred to as a first type switch and the thick-oxide switches may be referred to as a second type switch

In circuit 100, a first input signal labeled HS_on can be received by the level shifter input stage 114. The first input signal can be a relatively low voltage signal having a range of, for example, 0.9 V to 1.5 V. The level shifter input stage 114 can translate the first input signal from the low voltage domain to a floating relatively high voltage domain by transmitting the first input signal to the level shifter output stage 112. A corresponding turn-on signal can be generated and transmitted to the deglitching logic circuit 110. The turn-on signal can be buffered by the high-side buffer circuits and transmitted to the high-side power FET driver 106. An output signal of the high-side power FET driver 106 can control a conductivity state of the high-side N-channel switch 102. A second input signal labeled LS_on can be received by the low-side buffer circuit 118 and transmitted to the low-side power FET driver circuit 116. An output signal of the low-side power FET driver 116 can control a conductivity state of the low-side N-channel switch 104.

In the illustrated embodiment, the high-side pre-drive circuits can be arranged to be powered by the auxiliary bootstrap capacitor 136, while the high-side power FET driver can be arranged to be powered by the main bootstrap capacitor 130. In this way, a voltage drop for the pre-drive circuits can be minimized thereby reducing delay times in the pre-drive circuits, and delay times for the high-side pre-drive circuits and low-side pre-drive circuits can be matched with relatively high accuracy thereby preventing shoot-through in the half-bridge formed by the high-side N-channel switch 102 and the low-side N-channel switch 104. Further, noise can be reduced on the high-side pre-drive circuits since the auxiliary bootstrap capacitor 136 can operate with relatively low noise as compared to the relatively noisy main bootstrap capacitor 130. Moreover, voltage mismatch between high-side and low-side drivers can be reduced.

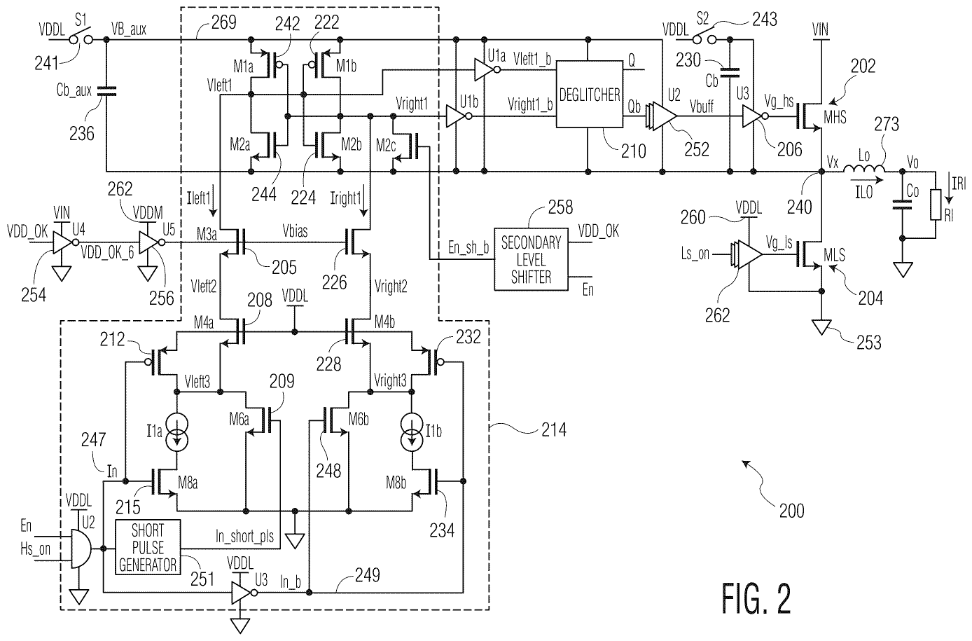

FIG. 2 illustrates a schematic of the DC-DC power converter circuit with N-channel MOSFET high-side and low-side switches with main and auxiliary bootstrap capacitors, using high-side drivers having floating level shifters and relatively low voltage controls, according to some embodiments. In FIG. 2, circuit 200 can include a bootstrap capacitor Cb 230 labeled Cb and an auxiliary capacitor 236 (labeled Cb_aux) for powering the high-side circuits. Circuit 200 can also include a level shifter circuit 214 having switches 242, 244, 205, 208, 212, 209, and 215 (labeled M1a-M8a, respectively), and 222, 224, 226, 228, 232, 248, and 234 (labeled M1b-M8b, respectively). The level shifter circuit 214 can be coupled to a deglitching logic circuit 210, a buffer circuit 252, and a power FET driver circuit 206. In some embodiments, circuits 252, 254 and 256, and a secondary level shifter circuit 258 can be used to turn off the high-side power FET 202 when internal power rails 260 (VDDL) and 262 (VDDM) have relatively low values during startup.

Circuit 200 can also include a low-side power FET driver 262 that is coupled to a LS MOSFET 204. Circuit 200 can additionally include an output inductor 273 labeled Lo, an output capacitor Co, and a load Rl. In some embodiments, power FET 202 and 204 can be a switch with relatively high voltage rating for the drain-source voltage and with a relatively low rating for the gate-source voltage. In various embodiments, power FETs 202 and 204 may be formed by using a stack of several relatively thin-oxide MOSFETs with relatively low voltage rating for drain-source and gate-source voltages. By using thin-oxide MOSFETs, the power converter can operate with increased efficiency and at a relatively faster speed.

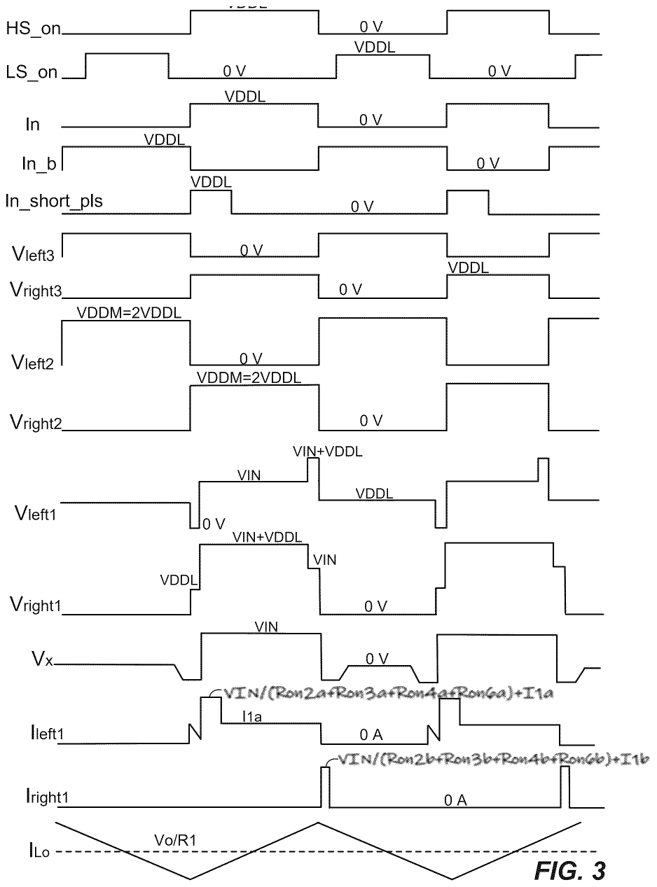

An operation of the circuit 200 is now described. In a normal mode of operation, signals En and VDD_OK may be high. A bias voltage Vbias on gate terminals of switches M3a and M3b's can be set to VDDM=2*VDDL. The operational waveforms of the circuit 200 are shown in FIG. 3. When the LS FET MLS (204) is on, voltage Vx at the switch node 240 can be pulled to ground. Switch 241 labeled S1 and switch 243 labeled S2 can be closed to replenish capacitors Cb_aux (236) and Cb (230) to VDDL voltage. After the LS FET MLS (204) is off and the input Hs_on goes high, S1 and S2 are opened while signal 247 labeled Iₙ is high and its inverse signal 249 labeled Iₙ_b is low. Signal Iₙ_short_pls is a short pulse that is generated when signal Iₙ transitions from low to high. Since Iₙ_b is low, N-channel FETs M6b and M8b are both off while P-channel M7b is on. As a result, Vright3=VDDL and M4b is off. Thus, there is no longer pull-down current through M3b and M4b from the right leg of the input level shifter. On the other hand, N-channel FETs M6a and M8a can both be on while P-channel FET M7a is off. Therefore, Vleft3 may be pulled low, thus turning on the M4a. In turn, Vleft2 is also pulled low through M4a that subsequently turns on M3a. Eventually, Vleft1 is pulled low through M3a and M4a. Because Vleft1 is low, M1b is on and M2b is off, thus pulling Vright1 to high. It is noted that Vleft1 is held at Vx through the turn-on M2a, thus clamping voltage stresses across switches M1a-M4a and M1b-M4b within the differential voltage of the auxiliary bootstrap capacitor Cb_aux, which is smaller than VDDL when Vx rises to VIN as described below.

After Vleft1 is low and Vright1 is high, these signals may be inverted to Vleft1_b and Vright1_b, and propagated through the deglitching logic circuit 210, buffer circuit 252, the last stage inverter circuit 206, to generate a voltage Vg_hs high at the gate terminal of the HS power FET MHS (202). The HS power FET MHS hence turns on and pulls up Vx to the input voltage VIN. Since Vleft1 is held at Vx through the turn-on M2a, there may be a relatively large current pulled from Vx through switches M3a, M4a, and M6a. Therefore, circuit 251 labeled short_pulse_generator can assist in cutting off M6a after Vx rises high. The pulse width of Iₙ_short_pls may be relatively longer than the total delay of the HS driver so that it may falls to low state relatively soon after MHS (202) turns on. There may still be a pull-down current of I1a at Vleft1 through M7a, I1a, and M8a. However, the current I1a may be relatively smaller than the current pulled by M6a. This short-pulse mechanism can reduce the overall power consumption of the input level shifter.

In order to turn off the HS FET MHS (202), the signal Hs_on is toggled to low, thus changing Iₙ to low state and Iₙ_b to high state. As a result, M6a and M8a are turned off while M6b and M8b are turned on to pull down Vright3, Vright2, and Vright 1 sequentially. Low state Vright1 can turn on switch M1a to pull up Vleft1 to VB_aux. As Vleft1 signal becomes high, it switches M2b to on state for holding Vright1 at Vx level. The changed levels of Vleft1 and Vright1 can propagate through the deglitching logic circuit 210, U2 (252), and U3 (206), to switch off MHS 202. The LS FET MLS 204 can be on for a relatively brief time period later to pull Vx down to power ground 253. Subsequently, switches S1 and S2 may be closed to recharge bootstrap capacitors Cb and Cb_aux to VDDL and complete a switching cycle.

Voltage stresses on the stacks of M3a and M4a, as well as M3b and M4b are determined by their gate bias voltages. The gates of M3a and M3b are at VDDM in normal operation while that of M4a and M4b are tied to VDDL. VDDL can be a nominal operation voltage of thin-oxide FETs, which is close to the breakdown voltage of thin-oxide FETs in a CMOS process. The voltages Vleft3 and Vright3 at the sources of M4a and M4b are clamped below their gate voltages at VDDL because the N-channel FETs will be off once their sources voltages are close to their gate voltages. Similarly, Vleft2 and Vright2 can be clamped below VDDM by M3a and M3b. To maximize a overdrive voltage of M3a and M3b while keeping the voltage stress on M4a and M4b under VDDL, VDDM=2*VDDL can be used. This VDDM value allows Vleft1 and Vright1 to be as high as V_{BK,thick}+2*VDDL, where V_{BK,thick} is the breakdown voltage of thick-oxide devices. As a result, Vlef1 and Vleft2 can be up to V_{BK,thick}+2*VDDL without causing voltage stress issues for turn-off FETs used in the level shifter 214. In other words, VB and VB_aux are allowed to be 2*VDDL above V_{BK,thick}. In a modern CMOS process, the thick-oxide MOSFETs' breakdown voltage V_{BK,thick} can be between 2-3 times as that of the thin-oxide breakdown voltage, thus allowing VB and VB_aux to be 4-5 times of VDDL.

As previously stated, one advantage of the disclosed circuit structure can be to increase the overdrive voltage of thick-oxide devices. When either M3a or M3b are on, their gate-source voltage can be equal to Vbias=VDDM=2*VDDL. This voltage may provide sufficiently large overdrive voltage for these thick-oxide FETs. This can be particularly useful for applications with low VDDL. Additionally, a relatively larger overdrive voltage may allow M3a and M3b to be implemented with smaller-size FETs, thus reducing the parasitic capacitance to achieve a relatively faster operating speed.

Furthermore, two separate bootstrap capacitors Cb 230 and Cb_aux 236 can reduce the total delay of the high-side drive circuitry substantially. It is noted that a relatively large amount of charge is used for the HS FET MHS' 202 gate capacitance to turn on this FET strongly due to its relatively large size as a power switch. Charge sharing between Cb 230 and the HS FET MHS' 202 can cause a substantial voltage-drop on Cb 230. By using an auxiliary Cb_aux 236 in addition to a bootstrap capacitor Cb 230, the voltage drop on the level shifter circuit 214, deglitching circuit 210, and buffer circuits of the high-side drive chain can be minimized. Thus, the total propagation delay of the high-side drive chain can be substantially the same as that of the low-side drive chain, where the low-side drive chain uses a fixed supply voltage of VDD_{L}.

Moreover, by using an auxiliary Cb_aux 236 in addition to a bootstrap capacitor Cb 230, the accumulative delay from Iₙ to Vbuff can be shortened. Moreover, by using relatively smaller devices in the level shifter circuit 214, deglitching circuit 210, and buffer circuit U2 252, as compared to the devices used in inverter U3 206 and power FET MHS 202, the voltage drop of Cb_aux 236 can be substantially less than that of Cb 230 even though the size of the auxiliary capacitor Cb_aux 236 is relatively smaller. For example, with the same total capacitance budget for Cb and Cb_aux, the capacitor separation technique can reduce the total delay by a factor of up to, for example, 2 times at the slow-slow (SS) corner in 55 nm CMOS process.

In addition to the normal operational performance, during the startup of the circuit it is beneficial to ensure the high-side driver output is at an optimum turn-off state. During the startup, VDDL and VDDM may be relatively low for digital circuits to operate properly while VIN being high may cause damage to the devices when a wrong state of the power stage is present. In some embodiment, internal power-good signal may be generated, namely VDD_OK in FIG. 2, to indicate if VDDL and VDDM are sufficiently high for their supplied circuits. In various embodiments, the high-side driver may use the VDD_OK signal to force the gate voltage Vg_hs of the HS FET MHS 202 by use of a secondary level shifter circuit 258 depicted. In some embodiments, the secondary level shifter circuit 258 can be relatively slower than the main level shifter 214, however the secondary level shifter circuit 258 can operate independent of VDDM and VDD_{L}, and can operate using a relatively low quiescent current so as to not affect the power efficiency. The secondary level shifter circuit 258 may be arranged to receive an enable signal En at an enable pin. The En signal can force the HS FET MHS 202 to turn off even after VDDH and VDDL are ready and VDD_OK is high. The complete truth table of the HS driver control logic is presented in Table 1.

| VDD_OK | En | In | Vg_hs |
|---|---|---|---|
| Low | X | X | Low |
| X | Low | X | Low |
| High | High | Low | Low |
| High | High | High | High |

In FIG. 2, when VDD_OK is low during the startup, VDD_OK_b is hence held high at VIN, thus pulling Vbias to ground regardless of VDDM level. Consequently, it may block any pull-down current from M3a-M8a and M3b-M8b because M3a and M3b are off.

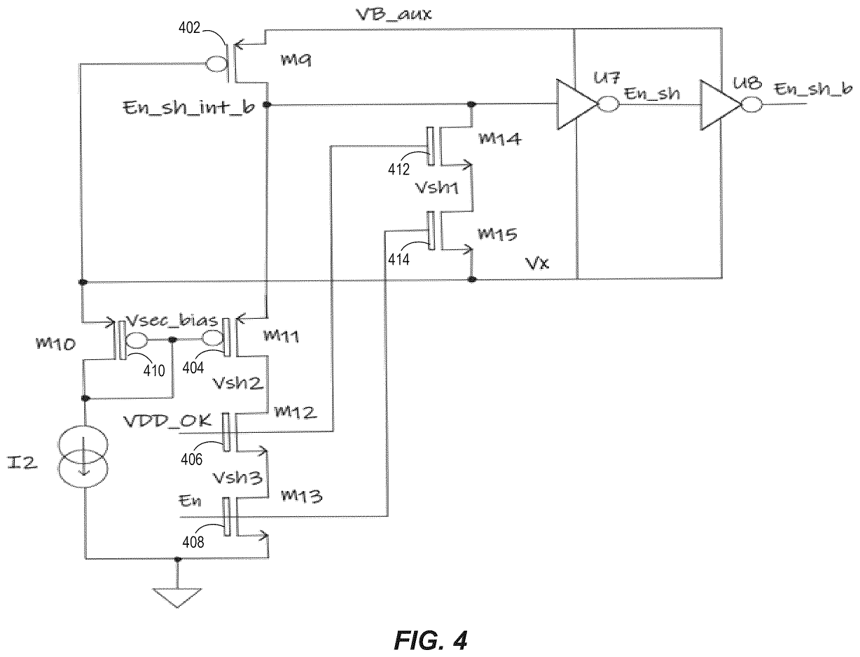

FIG. 4 illustrates a schematic of the secondary level shifter circuit 258, according to some embodiments. A P-channel FET 402 labeled Ma can be coupled to the VB_aux node 269. P-channel FET 404 labeled M11 can be coupled to the P-channel FET 402. P-channel FET 406 labeled M12 can be coupled to the P-channel FET 404. P-channel FET 408 labeled M13 can be coupled to the P-channel FET 406. P-channel FET 410 labeled M10 can be coupled to the P-channel FET 404. N-channel FET 412 labeled M14 can be coupled to the P-channel FET 406. N-channel FET 414 labeled M15 can be coupled to the P-channel FET 408. In various embodiments, the secondary level shifter circuit 258 can operate based on a pseudo-PMOS logic, with P-channel FET Ma 402 being on. When VDD_OK is low, there is no pull-down current at En_sh_int_b since M12 and M14 are both off. En_sh_int_b is hence pulled high to VB_aux 269 through P-channel FET 402 Ma, thus asserting its output En_sh_b high. As a result, M2c switch of FIG. 2 is on and pulls Vright1 low to Vx, which can cause Vleft1 to go high by action of the cross-couple circuit. Subsequently, these signals propagate along the high-side driver chain to set Vg_hs low at the gate of HS FET MHS 202, thus assuring that HS FET MHS 202 is turned off.

In FIG. 4, when VDD_OK is high, En_sh_int_b is determined by En signal. When En is low, the pull-down currents are blocked causing En_sh_int_b to be pulled up by Ma. At the same time, input signal Iₙ of the main level shifter in FIG. 2 is gated by the same En signal so that Iₙ is also low. Thus, Vg_hs is forced low in a similar manner to VDD_OK being low. When En is high, En_sh_int_b can be pulled down either by M11-M13 or by M14 and M15, depending on Vx level. When Vx is low, M14 and M15 are on to pull down En_sh_int_b while P-channel FETs M10 and M11 can be off because of insufficient voltage headroom.

When Vx rises high, M14 and M15 may turn off since the gate terminals of these N-channel FETs can experience lower voltages than their source terminals. At the same time, M10 and M11 can turn on and enter the saturation mode to mirror the current I2 to M11-M13. I2 current can have a relatively high value so that the pull-down current through M11-M13 is stronger than the pull-up current through Ma. This pull-down current can hold En_sh_int_b low. As a result, En_sh_b in FIG. 4 may remain low at any level of Vx, thus ensuring M2c of FIG. 2 is in off state. Therefore, signals Vright1 and Vleft1 of the main level shifter as well as Vg_hs of the high-side driver in FIG. 2 can be determined by input signal Iₙ when the high-side driver is active.

To limit the voltage stress across Ma in FIG. 4, when En_sh_int_b is pulled down, the gate of M11 is biased by Vsec_bias signal, which is generated by the current mirror circuit consisting of I2, M10, and M11. This circuit can play the role of clamping En_sh_int_b so that this node may not be lower than Vx. The clamp function can be implemented by increasing the size of M10 and M11 to a relatively large value such that M10 and M11 can have minimal overdrive voltages. Consequently, once Vx is high, Vsec_bias is about one threshold Vthp below Vx. Thus, En_sh_int_b can have a value relatively close to Vx as one threshold above Vsec_bias. Therefore, the voltage stress across the thin-oxide Ma is within VB_aux-Vx, or VDDL. Moreover, M11-M15 can be thick-oxide devices in order to withstand the voltage stress of VIN when Vx swings in this range.

In some embodiments, combination of the circuits and methods disclosed herein can be utilized to provide DC-DC converters with N-channel high-side switches using high-side drivers having low voltage controls and floating level shifters. Although circuits and methods are described and illustrated herein with respect to several particular configuration of DC-DC converters, embodiments of the disclosure are suitable for high-side drivers having low voltage controls and floating level shifters used in other topologies such as, but not limited to, motor control and high-voltage power converters.

In some embodiments, the described switches can be formed in silicon, or any other semiconductor material. In various embodiments, the described switches can be transistors. In some embodiments, the described switches can be metal oxide semiconductor field effect transistors (MOSFETs). In various embodiments, the disclosed MOSFETS can all be formed on one single die well. In some embodiments, the disclosed DC-DC converter can be monolithically integrated onto a single die. In various embodiments, the high-side and the low-side can be formed on separate individual die. In various embodiments, the disclosed DC-DC converter be integrated into one electronic package, for example, but not limited to, into a quad-flat no-lead (QFN) package, or into a dual-flat no-leads (DFN) package, into a ball grid array (BGA) package. In various embodiments, controller circuits and/or control logic circuits can be integrated into a single die along with the disclosed DC-DC converter.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A level shift circuit comprising:
an input circuit comprising a first and second input terminals;
an output circuit comprising a first and second output terminals;
a first switch coupled to a second switch, the first and second switches being of a first type of switch;
a third switch coupled to the second switch, the third switch being of a second type of switch; and
wherein the first and the second input terminals are referenced to a first voltage that is a ground, and the first and the second output terminals are referenced to a second voltage at a different potential than ground.

2. The level shift circuit of claim 1, wherein the first type of switch is characterized as having a first breakdown voltage, wherein the second type of switch is characterized as having a second breakdown voltage, and wherein the first breakdown voltage is less than the second breakdown voltage.

3. The level shift circuit of claim 1, wherein the first type of switch is characterized as having a first gate oxide thickness, and wherein the second type of switch is characterized as having a second gate oxide thickness.

4. The level shift circuit of claim 3, wherein the first gate oxide thickness is less than the second gate oxide thickness.

5. The level shift circuit of claim 1, wherein the first switch is arranged to receive a first of a plurality of control signals and to selectively conduct current according to the first control signal.

6. The level shift circuit of claim 1, wherein the third switch is arranged to enable the output circuit upon receiving of an enable signal being high.

7. The level shift circuit of claim 1, wherein the second input terminal is coupled to a gate terminal of the third switch.

8. A circuit comprising:
a first switch coupled to a second switch at a switch node;
a driver circuit coupled to the first switch;
a first bootstrap switch;
a first bootstrap capacitor coupled to the switch node and to the first bootstrap switch, the first bootstrap capacitor arranged to supply a first power voltage to the driver circuit;
a pre-driver circuit coupled to the driver circuit;
a second bootstrap switch; and
a second bootstrap capacitor coupled to the switch node and to the second bootstrap switch, the second bootstrap capacitor arranged to supply a second power voltage to the pre-driver circuit.

9. The circuit of claim 8, wherein a voltage at the switch node changes between first and second switch node voltages and wherein the first bootstrap capacitor is arranged to supply the first power voltage while the voltage at the switch node is equal to the second switch node voltage.

10. The circuit of claim 9, wherein the first bootstrap switch is arranged to couple the first bootstrap capacitor to a power node having the second power voltage while the voltage at the switch node is equal to the first switch node voltage.

11. The circuit of claim 9, wherein the second bootstrap capacitor is arranged to supply the second power voltage while the voltage at the switch node is equal to the second switch node voltage.

12. The circuit of claim 11, wherein the second bootstrap switch is arranged to couple the second bootstrap capacitor to a power node having the second power voltage while the voltage at the switch node is equal to the first switch node voltage.

13. The circuit of claim 10, wherein the pre-driver circuit comprises an output of a level shift circuit, a buffer circuit and a deglitching circuit.

14. The circuit of claim 8, wherein a voltage drop at the second bootstrap capacitor is less than that of the first bootstrap capacitor.

15. A method of operating a circuit, the method comprising:
providing a first switch coupled to a second switch at a switch node, wherein the switch node changes between first and second switch node voltages;
providing a driver circuit coupled to the first switch;
providing a pre-driver circuit coupled to the driver circuit;
providing a first bootstrap capacitor coupled to the switch node;
supplying, by the first bootstrap capacitor, a first power voltage to the driver circuit;
providing a second bootstrap capacitor coupled to the switch node; and
supplying, by the second bootstrap capacitor, a second power voltage to the pre-driver circuit.

16. The method of claim 15, further comprising providing a first bootstrap switch coupled to the first bootstrap capacitor.

17. The method of claim 16, further comprising providing a second bootstrap switch coupled to the second bootstrap capacitor.

18. The method of claim 17, wherein the first bootstrap capacitor is arranged to supply the first power voltage while the voltage at the switch node is equal to the second switch node voltage.

19. The method of claim 18, wherein the first bootstrap switch is arranged to couple the first bootstrap capacitor to a power node having the second power voltage while the voltage at the switch node is equal to the first switch node voltage.

20. The method of claim 19, wherein the second bootstrap capacitor is arranged to supply the second power voltage while the voltage at the switch node is equal to the second switch node voltage.
